(19) United States
(12) Patent Application Publication
(10) Pub. No.: US 2026/0223259 A1
(43) Pub. Date: Jul. 30, 2026

(54) COOKING APPLIANCE HAVING AN ANTENNA ARRANGED OUTSIDE THE COOKING CHAMBER

(71) Applicant: BSH Hausgeräte GmbH, Munich (DE)

(72) Inventors: Manfred Steinbacher, Inzell (DE); Markus Kuchler, Gstactt am Chiemsee (DE); Andreas Kaiser, Halfing (DE)

(21) Appl. No.: 19/146,955

(22) PCT Filed: Feb. 12, 2024
(86) PCT No.: PCT/EP2024/053473

§ 371 Date: Jul. 10, 2025

(30) Foreign Application Priority Data
Feb. 15, 2023 (DE) 10 2023 201 293.6

(51) Int. Cl. H05B 6/64; F24C 7/08; H05B 6/76

(52) U.S. Cl. CPC H05B 6/6452; F24C 7/08; H05B 6/6467; H05B 6/76

(57) ABSTRACT

A cooking appliance includes a closable cooking chamber including a leakage path, arranged between the cooking chamber and its outer surroundings, for electromagnetic waves, and a free-standing antenna, arranged in the outer surroundings of the cooking chamber, for data signals transmitted via the leakage path. The antenna is connected to a transmission and/or receiving circuit for the data signals.

The invention relates to a cooking appliance having a closable cooking chamber with at least one path, arranged between the cooking chamber and its outer surroundings, for electromagnetic waves, and an antenna, arranged in outer surroundings of the cooking chamber, for transmitted data signals, said antenna being connected to a transmission and/or receiving circuit for the data signals. The invention also relates to a system having such a cooking appliance and a functional unit which is to be arranged in the cooking chamber and which is equipped with a wireless transmission and/or receiving device for the data signals. The invention further relates to a method in which data signals are transmitted between a functional unit arranged in a closed cooking chamber of a cooking appliance and a transmission and/or receiving circuit arranged in outer surroundings of the cooking chamber. The invention is, in particular, advantageously applicable to ovens with, but also without, a microwave function.

DE 10 2009 027 920 A1 discloses a cooking appliance which has a cooking appliance muffle which defines a cooking chamber and a fan for blowing air into the cooking chamber. An electrical controller which is electrically connected to an antenna is arranged in the cooking appliance. The antenna is provided for transmitting signals to a measuring device located in the cooking chamber and is a constituent part of the fan.

DE 10 2013 114 066 A1 discloses a fan wheel for a cooking appliance with a shaft, which can be connected to a drive unit for rotating the fan wheel and a source of electromagnetic waves and/or a receiving unit for electromagnetic waves, at least one waveguide for electromagnetic waves and at least one antenna which is connected to the at least one waveguide. The invention also relates to a cooking appliance having at least one such fan wheel and a cooking method for such a cooking appliance.

EP 0 459 305 B1 discloses a high-frequency heating appliance with a high-frequency oscillator for generating high-frequency oscillations from electrical energy of a power supply unit; with a housing in the form of a rectangular parallelepiped which encloses a heating chamber into which the high-frequency oscillations of the high-frequency oscillator are introduced; with an antenna arranged outside the heating chamber and adjoining an elongated opening in the wall of the housing; with a dielectric plate which covers the opening and which is arranged on the wall of the housing such that the opening lies between the dielectric plate and the antenna; with a detector which receives the output signal of the antenna and has a grounded portion which is connected to the housing; and with a control circuit to which the output signal of the detector is supplied and which outputs a control signal to the power supply unit; wherein the housing has the contour of a straight wall portion in a plane in which the opening opposes the dielectric plate, and the elongated opening runs with its longitudinal direction obliquely to the straight wall portion of the contour.

EP 3 188 571 B1 discloses a cooking appliance comprising: a housing which encloses an interior, wherein at least one portion of the housing encompasses an electrically conductive portion; and an antenna for at least one of the following: receiving high-frequency signals and transmitting high-frequency signals, wherein the antenna comprises an active component and a connection to the electrically conductive portion such that the electrically conductive portion serves as a ground plane of the antenna, wherein the housing further comprises a door arrangement which has a closed position and an open position in order to permit access to the interior by a user, wherein the door arrangement encloses a window in order to permit a view of the interior from outside the interior; wherein the window encloses the electrically conductive portion in the form of at least one transparent conductive layer.

EP 3 443 267 B1 discloses a cooking appliance with a cooking chamber for cooking food to be cooked, with an air guiding plate arranged in the cooking chamber, a transmission/receiving unit for transmitting and/or receiving a high-frequency signal, and a coupling apparatus for coupling the transmission/receiving unit and the air guiding plate, wherein the air guiding plate is configured as a flat antenna for transmitting the high-frequency signal between the coupling apparatus and a sensor which can be arranged in the cooking chamber, wherein the coupling apparatus comprises a spiral-shaped electrical line for capacitive coupling to the air guiding plate in order to transmit the high-frequency signal.

WO 2006/111226 A1 discloses a household appliance, in particular a cooking appliance, with an interior defined by a housing and a door, an electrical controller and a measuring device for measuring a physical parameter, in particular the temperature, wherein, for wireless signal transmission between a measuring probe arranged in the interior and the electrical controller, the measuring device has a probe antenna arranged on the measuring probe and a transmission or receiving antenna which is connected in a signal-transmitting manner to the electrical controller and which is arranged on the housing and is sealed in a substantially air-tight manner relative to the interior by a cover which is permeable to electromagnetic radiation. In order to specify a household appliance in which the manufacturing effort and thus the costs are reduced, the transmission or receiving antenna is a constituent part of a lighting device for illuminating the interior.

DE 10 2007 043 370 B3 discloses a household appliance with a treatment chamber, an electrical controller and a rod antenna which has an elongated base body which is defined in the longitudinal direction by two front ends, wherein the rod antenna is held in the treatment chamber on a wall of the treatment chamber, electrical signals being transmitted wirelessly thereby between a transmission or receiving device arranged in the treatment chamber and the electrical controller.

DE 10 2011 109 163 A1 discloses an oven with a heating element arranged in a treatment chamber of the oven with a metallic outer shell and a holding flange, wherein the heating element is fastened to the holding flange via the metallic outer shell, and an interrogation antenna of a wireless measuring system for monitoring an item in the oven. According to the invention, the interrogation antenna of the wireless measuring system is formed by the heating element in the treatment chamber of the oven, by the metallic outer shell of the heating element being insulated relative to the holding flange at least at one connection end.

EP 2 662 629 A1 discloses a household appliance with a treatment chamber to which an antenna is assigned. A coupling arrangement which is operatively connected to the antenna via a connecting device is provided in the treatment chamber.

EP 2 663 160 A1 discloses a household appliance with a treatment chamber and with a coupling device for transmitting electromagnetic radiation into the treatment chamber. The coupling device is arranged in a secondary chamber. The secondary chamber is separated from the treatment chamber via at least one partition wall. The coupling device is configured to generate an electromagnetic field between a first metallic wall and an adjacent second metallic wall. At least one opening is provided, at least the transmission of the electromagnetic radiation into the treatment chamber taking place thereby.

DE 10 2012 221 015 A1 discloses a cooking appliance, in particular an oven, which has a cooking chamber with cooking chamber walls and a fan opening into the cooking chamber. This fan opening is provided on a fan plate which is attached in front of a cooking chamber wall, wherein an antenna for wireless signal transmission is provided with a measuring device having a transmission and receiving antenna located in the cooking chamber. The antenna is arranged between the fan plate and cooking chamber wall and thus is covered or protected toward the inside.

EP 2 741 009 A1 discloses a heating and signal receiving arrangement for a cooking appliance with a cooking chamber, said cooking appliance being able to be arranged in the cooking chamber, and which comprises a heating element and a signal receiving element, wherein the signal receiving element is designed as a slot antenna which is thermally connected directly to the heating element. Also disclosed is a cooking appliance with such a heating and signal receiving arrangement.

EP 3 121 573 A1 discloses an oven, in particular an oven or microwave oven, with an oven muffle for active temperature treatment of a substance and for receiving the substance via a chamber opening, a door which is designed for opening and closing the chamber opening in a first or second position, at least one receiving or transmission/receiving element which permits an at least unidirectional wireless communication of signals from and/or to at least one sensor unit which is placed on or in the oven muffle, wherein: the at least one receiving or transmission-receiving element is positioned inside an intermediate space between two walls and/or panes of the door.

WO 2021/239233 A1 discloses a microwave oven, a sensor arrangement, a system which comprises a microwave oven and a sensor arrangement and a corresponding method for controlling a microwave oven. The method comprises: measuring the temperature; providing first data; accessing second data; providing control data; communicating sensor arrangement data which comprises the control data or comprises the first and second data; and controlling the microwave oven as a function of the control data.

WO 2022/008050 A1 discloses a sensor arrangement and a receiver arrangement for a microwave oven. The sensor arrangement can receive energy from the microwave radiation and generate a modulated backscatter signal of a higher harmonic. The receiver arrangement can receive and extract the modulated backscatter signal from the intense background microwave radiation.

It is the object of the present invention to remedy at least partially the drawbacks of the prior art and, in particular, to provide a possibility which can be implemented in a particularly simple and cost-effective manner for conducting data signals from a closed cooking chamber toward the outside and/or for conducting said data signals into the closed cooking chamber from the outside.

This object is achieved according to the features of the independent claims. Preferred embodiments can be found, in particular, in the dependent claims.

The object is achieved by a cooking appliance, having
a closable cooking chamber with at least one leakage path, arranged between the cooking chamber and its outer surroundings, for electromagnetic waves, and
a free-standing antenna, arranged in outer surroundings of the cooking chamber, for data signals transmitted via the at least one leakage path,
said antenna being connected to a transmission and/or receiving circuit for the data signals.

This achieves the advantage that electromagnetic leakage paths which are already present are now also used for the signal transmission and it is possible to dispense with a specific design of the cooking chamber wall and/or the door, for example by through-passages provided specifically for routing signals or by antennae routed through the cooking chamber wall and/or the door and specifically adapted for conducting data signals. In particular, by dispensing with specific through-passages in the cooking chamber wall and/or the door, it is possible to avoid the drawbacks associated therewith, such as greater heat loss, greater escape of microwave radiation, escape of steam and/or escape of hot air, etc.

The cooking appliance is, in particular, a household cooking appliance. The cooking appliance can have, for example, an oven function, a microwave function, a steam treatment function, a vacuum function or any combination thereof, and thus for example can be an oven, a microwave appliance, an oven/microwave combination appliance, a steam cooking appliance, a rice cooker, etc.

The cooking chamber can be closed by a door, for example on the front, or by a lid. In the closed-off or closed state, the cooking chamber is not fully sealed relative to electromagnetic radiation, for example radio waves, but electromagnetic radiation can penetrate from the outside into the cooking chamber and/or escape from the cooking chamber to the outside via leakage paths.

A “leakage path” is understood to mean, in particular, a path for electromagnetic radiation, possibly of a specific frequency band, which is not specifically provided or adapted for conducting the electromagnetic radiation. The electromagnetic radiation is generally attenuated when routed via the leakage path. A leakage path, in particular, is not understood to mean a signal path in which the data signals are conducted through a cooking chamber boundary using an electrical conductor which is provided or adapted specifically therefor, and namely in particular not when this electrical conductor takes on further functions. Thus, in particular, signal paths through shafts or axles, fan wheels, lamp holders, etc. which are configured specifically for conducting data are not considered as leakage paths. Moreover, in particular, signal paths through openings incorporated into the cooking chamber boundary specifically for routing signals are not considered as leakage paths.

The antenna is sensitive to the data signals. The antenna comprises, in particular, at least one electrical conductor, for example wire, printed conductor, etc. The fact that the antenna is free-standing encompasses, in particular, that it does not come into contact with any electrical conductor portion of the leakage path, if present at all. In other words, the antenna does not come into contact with the leakage path, for example not via sliding contacts, soldering points, plug connections, etc. The fact that the antenna is arranged on the outer surroundings of the cooking chamber can encompass, in particular, that the antenna is arranged outside the cooking chamber which is defined by the cooking chamber wall and the closed door.

The antenna can be, for example, a monopole, inverted-F, slot, coil or loop antenna, etc. but is not limited thereto, and in principle can have any shape. Any antenna shapes can be easily obtained, in particular, by printing an electrically non-conductive body with metallic tracks.

It is an advantageous development for a particularly good transmission quality that the antenna is to be or is adapted in terms of impedance to the frequency of the data signal to be transmitted. This can be undertaken by adjusting the mechanical dimensions to the type of antenna correspondingly used. Alternatively or additionally, an adaptation in terms of impedance can be achieved, for example, by providing transformation lines and/or passive structural elements, such as for example capacitors and inductors, for the desired transmission frequency range. The transformation line is the antenna line which is adapted in terms of length according to the transmission frequency under consideration.

The data signals comprise data or information transmitted, in particular, by electromagnetic waves. The data signals can have been modulated, for example, by amplitude modulation and/or angle modulation of an electromagnetic wave. The data signals can be digital or analog data signals. The data signals can comprise, for example, control signals, measurement signals, status signals, etc. The data signals can be, in particular, radio signals.

The fact that the antenna is connected to a transmission and/or receiving circuit for the data signals encompasses, in particular, that this circuit is also arranged outside the cooking chamber, which advantageously reduces thermal and other stresses on the circuit.

It is one development that the antenna is connected to the transmission and/or receiving circuit via an electrical line (“antenna line”). The antenna line is advantageously a shielded line, for example a coaxial line or a twisted pair cable in order to avoid stray influences. It is one development that the antenna and the antenna line are integrated in one component, for example in the form of a shielded wire, the end region thereof remote from the transmission and/or receiving circuit serving as free-standing antenna and being stripped of insulation for this purpose. However, the antenna can also be a separate component (for example an antenna module) which can be connected to the antenna line via a line connection. It is one development that the antenna line is routed in the vicinity of large ground surfaces (for example a housing plate, an intermediate rear wall, etc.) since in this manner impedance conditions can be kept substantially constant and electromagnetic interference substantially avoided.

The transmission and/or receiving circuit can be a pure transmission circuit (transmitter), data signals being able to be emitted thereby via the antenna and onward into the cooking chamber via the leakage path. Alternatively, the transmission and/or receiving circuit can be a pure receiving circuit (receiver), data signals being able to be received thereby from the cooking chamber via the leakage path and onward via the antenna. Moreover, the transmission and/or receiving circuit can be a transmission and receiving circuit (transceiver), data signals being able to be received thereby from the cooking chamber and being able to be emitted thereby into the cooking chamber. A signal evaluation can take place in the transmission and/or receiving circuit when designed for receiving data, for example by means of analog and digital signal processing.

It is one development that the transmission and/or receiving circuit is coupled to a data processing device of the cooking appliance, whereby the data signals can be advantageously used, for example, for monitoring and controlling a cooking process. The transmission and/or receiving circuit can be present as a separate module or can be integrated in the data processing device. The date processing device can be a control device for controlling an operation of the cooking appliance.

The present method thus also provides the advantage that the transmission and/or receiving circuit can be installed with the antenna outside the cooking chamber, without the remaining cooking appliance having to be adapted in the region of the leakage path. As a result, the method can be implemented in conventional cooking appliances with only minimal adaptation to the design. The antenna can be arranged anywhere outside the oven, firstly where this is possible mechanically and secondly where a sufficiently strong data signal or message signal is available.

It is one development that the transmission and/or receiving circuit is configured as an electronic subassembly or electronics with at least one printed circuit board. In this case, it is one development that the antenna is also configured on the printed circuit board, for example as an electrical coupling surface. The coupling surface can have been generated, for example, by printing, galvanizing, laser treatment, etc. An antenna line can be present on the conductor surface, for example in the form of a printed conductor, but optionally an antenna line can also be dispensed with. The transmission and/or receiving circuit, the antenna and, if present, the antenna line can be configured, in particular, as a module which can be handled as a unit.

It is one development that a least one leakage path has an electrical conductor routed through a boundary of the cooking chamber (for example through the cooking chamber wall and/or the door), the antenna is arranged spaced apart from this electrical conductor and the antenna is designed to exchange the data signals with the electrical conductor. This achieves the advantage of an antenna which is particularly wear-free and which can be positioned in a simple and variable manner. The electrical conductor protrudes into the cooking chamber, in particular from the outside through an opening in the cooking chamber boundary.

The fact that the antenna is designed to exchange the data signals with the electrical conductor encompasses, in particular, that it is designed to pick up data signals wirelessly from the electrical conductor and/or to feed said data signals wirelessly into the electrical conductor. The pick-up from the electrical conductor makes use of the fact that, due to the coupling of the data signals into the cooking chamber, the electrical conductor generates outside the cooking chamber an electromagnetic stray field which can be coupled into the antenna. Conversely, the antenna can generate a transmission field which is coupled into the electrical conductor outside the cooking chamber and generates a corresponding electromagnetic stray field in the cooking chamber.

The antenna can be coupled to the electrical conductor, for example inductively or capacitively. The electrical conductor can be or comprise at least one electrically conductive component which is routed or protrudes through the boundary of the cooking chamber, and optionally at least one further component which is electrically connected to this component outside the cooking chamber or the cooking chamber boundary. For example, both a motor shaft protruding through a cooking chamber wall and a drive motor connected thereto and/or a mounting thereof outside the cooking chamber can serve as sources for generating the stray field which can be picked up by the antenna.

It is one embodiment that the electrical conductor is part of a functional part protruding into the cooking chamber from the outer surroundings of the cooking chamber. This generally permits a particularly high and/or easily reproducible signal strength of the data signal.

It is one embodiment that the functional part is
a motor shaft of a hot air motor,
a grill heating element,
a lamp structure,
a sensor element,
an actuator element,
an electrical supply line and/or
a fastening element.

It is one embodiment that at least one leakage path between the cooking chamber and the outer surroundings is an air path, i.e. in particular the data signal does not run in any portion through an electrical conductor.

It is one development that the antenna is arranged in the region of a door slot or door gap. This is advantageous, since gap settings between the cooking chamber wall and door generally result in slots from which electromagnetic waves can escape. The air path thus runs, for example, through the door gap, in particular through a gap or slot between the door and door flange. In one development, the antenna can be arranged on an outer face of a door pane, for example adhesively bonded, screwed, printed with electrically conductive foil such as copper or aluminum, or vapor-deposited thereon. The antenna can also protrude into the door slot.

Since the control panel of an oven generally consists of radiation-permeable material (glass, plastics) and this is located in the vicinity above the oven door, a printed or physical antenna solution behind the control panel might also be conceivable. This has the advantage that the antenna line for the transmitter/receiver can be installed in a fixed manner and does not have to be routed via a hinge system, such as in the oven door, which potentially causes a disadvantageous movement of the line over time.

It is one embodiment that the air path leads through an opening, in particular slot, formed in particular in the boundary, in particular through a ventilation slot formed in the cooking chamber wall. This is advantageously particularly simple to implement.

It is one embodiment that the cooking appliance has a microwave function, in particular is a separate microwave appliance or an oven/microwave combination appliance, in particular an oven with a microwave function. In a cooking appliance with a microwave function, microwave leakage occurs via one or more leakage paths, for example through a door gap, wherein the strength of the microwave leakage radiation is limited for safety reasons, for example by structural measures such as providing a lambda/4 trap on the door gap, a perforated grille in a viewing window of the door, a corresponding dimensioning of openings in the cooking chamber wall, etc.

It is one embodiment that the electromagnetic waves used for transporting the data signals are in a frequency range outside the microwave frequency band used for the microwave function. This provides the advantage that the data signals are generally not attenuated as much as the microwave radiation, since the cooking appliance is designed for a particularly effective attenuation of the microwave leakage radiation and not, or not as much, for attenuation in other wavelength or frequency ranges. The microwave frequency band comprises, in particular, the frequencies of the microwaves generated by a microwave generating device of the cooking appliance or the microwaves propagated in the cooking chamber. The microwave frequency band can range, for example, between 902 MHz and 928 MHz or range between 2.4 and 2.5 GHZ. Generally, and not limited to specific frequency bands, in particular ISM bands, in one embodiment the at least one leakage path brings about an attenuation of microwaves and a lower attenuation of the data signals.

It is one development that the frequency range for the data signals is also within an ISM band, which provides regulatory advantages, specifically in a different ISM band from the ISM band used for the microwaves.

It is one embodiment that the frequency range used for the data signals is the 433 MHz ISM band. The frequencies thereof are between 433.05 MHz and 434.79 MHz This provides the advantage that dimensions of the antenna can have particularly practical values.

If the cooking appliance does not have a microwave function, however, the ISM band used for the data signals can also be the ISM band typically used for microwaves in the relevant region, i.e. for example the 902 MHz ISM band in the frequency range between 902 MHz and 928 MHz or the 2.4 GHz ISM band in the frequency range between 2.4 and 2.5 GHz.

If the appliance, in particular with a microwave function, has at least one slot, it is one embodiment that the slot is attenuating or has an attenuating effect for microwaves and serves as a resonator for the data signals or the frequency thereof, and thus leads to a high amplitude of the transmitted or received data signal. This corresponds to an adapted slot antenna. Advantageously, a narrow slot is provided, said slot being equivalent to a length corresponding to half a wavelength of the data signals, with a position of the data signals in the 433 MHz frequency band, for example with a length of ca. 35 cm.

The slot can be, for example, a ventilation slot or a portion of the door gap which is configured in the cooking chamber wall.

The object is also achieved by a system having a cooking appliance as described above and a functional unit which is to be arranged or is arranged in the cooking chamber and which is provided with a wireless transmission and/or receiving device for the data signals, wherein when the cooking chamber is closed—in particular also during a cooking process—data signals can be transmitted between this transmission and/or receiving device and the transmission and/or receiving circuit of the cooking appliance via at least one leakage path (i.e. can be coupled into the cooking chamber from the outside and/or can be decoupled from the cooking chamber toward the outside). The system can be configured in an analogous manner to the cooking appliance, and vice versa, and has the same advantages. The transmission and/or receiving circuit of the cooking appliance and thus also the cooking appliance equipped therewith, on the one hand, and the functional unit arranged in the cooking chamber, on the other hand, can thus communicate with one another unidirectionally or bidirectionally via at least one leakage path even when the cooking chamber is closed. The transmission and/or receiving device of the functional unit can be configured so as to be adapted to the transmission and/or receiving circuit of the cooking appliance, for example as a transmitter if the transmission and/or receiving circuit of the cooking appliance has a receiver or transceiver, as a receiver if the transmission and/or receiving circuit of the cooking appliance has a transmitter or transceiver, or as a transceiver.

The functional unit, which can also be denoted as an “application”, can emit actively or automatically data signals, for example measurement signals, via its transmission and/or receiving device, for example at regular time intervals. The functional unit can additionally or alternatively be interrogated by the transmission and/or receiving circuit of the cooking appliance, for example by the transmission and/or receiving circuit transmitting a data signal, for example comprising a control command or an interrogation signal to the functional unit, and receiving a response signal as a response, for example a measurement signal or a measured value. Additionally or alternatively, a data signal, for example comprising an interrogation signal, can be transmitted outside the cooking chamber from the functional unit inside the cooking chamber of the transmission and/or receiving circuit, whereupon the transmission and/or receiving circuit transmits a response signal back to the functional unit. For a clear data signal (for example with a high amplitude and/or low signal-to-noise ratio), it is advantageous if the transmission and/or receiving circuit of the cooking appliance and the transmission and/or receiving device of the functional unit are active, in particular electrically operated, units.

The functional unit or application can be, for example, a core temperature probe which transmits to the transmission and/or receiving circuit the temperature data measured thereby of a food to be cooked which is located in the cooking chamber. The signal evaluation can take place therein, for example by means of analog and digital signal processing.

Additionally or alternatively to a core temperature probe, it is possible to use as a functional unit at least one unit from the group
humidity sensor;
weighing unit;
chemical sensor;
status indicator;
pressure sensor.

The object is also achieved by a method in which data signals are transmitted between a functional unit arranged in a closed cooking chamber of a cooking appliance and a transmission and/or receiving circuit arranged in outer surroundings of the cooking chamber via at least one leakage path arranged between the cooking chamber and its outer surroundings. The method can also be configured in an analogous manner to the cooking appliance and to the system, and vice versa, and has the same advantages.

The above-described properties, features and advantages of this invention and the manner in which they are achieved, will become clearer and more readily understood in connection with the following schematic description of an exemplary embodiment which is explained in more detail in connection with the drawings.

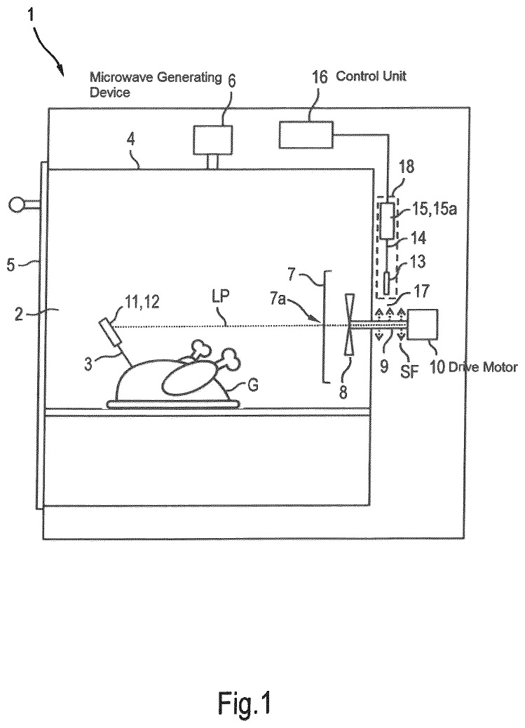

FIG. 1 shows as a sectional side view a sketch of a system with a cooking appliance and a functional unit accommodated in a closed cooking chamber of the cooking appliance.

FIG. 1 shows as a sectional side view a sketch of a system 1, 3 with a cooking appliance 1 in the form of an oven/microwave combination appliance selected by way of example and a functional unit in the form of a core temperature probe 3 selected by way of example and accommodated in a closed cooking chamber 2 of the cooking appliance 1. The cooking chamber 2 is defined by means of a cooking chamber wall, which can also be denoted as a muffle 4 or oven, and a door 5 closing a front loading opening of the muffle 4. The cooking appliance 1 has a microwave generating device 6 which is, for example, semi-conductor-based or configured as a magnetron and which generates microwaves in the 2.4 GHz ISM band, which are fed into the cooking chamber 2 when the microwave generating device 6 is activated.

A fan wheel 8 which circulates the air in the muffle 4 when rotated is located on a rear wall of the muffle behind a baffle wall 7 serving as an air guiding plate. An annular heating element (not shown) can be assigned to the fan wheel 8, a hot air operation being able to be implemented during the operation thereof and the simultaneous rotation of the fan wheel 8. The baffle wall 7 is provided with air slots 7a for a uniform air circulation. The fan wheel 8 is attached to an electrically conductive, for example metallic, motor shaft 9 of a drive motor 10 which is arranged outside the muffle 4 and which rotates at the speed of the motor shaft 9. The fan wheel 8, the motor shaft 9 and the drive motor 10 can also be denoted together as the “hot fan subassembly”.

The skewer of the core temperature probe 3 in this case is inserted into the food to be cooked G. At least one temperature sensor (not shown) is located in the skewer, a (“core”) temperature being able to be detected thereby in the interior of the food to be cooked G. The measuring voltages detected by the temperature sensor can optionally be digitized by means of a circuit located in a grip 11 of the core temperature probe 3. An active transmitter 12, which is also located in the grip 11, transmits the measured values as data signals in analog or digital form via radio in the 433 MHz ISM band. For example, the measured values of a carrier wave in the 433 MHz ISM band can be correspondingly modulated in terms of amplitude and/or angle. The data signals are propagated in the cooking chamber 2 through the slots incorporated in the baffle wall 7 as far as the fan wheel 8 and the motor shaft 9, into which the data signals are coupled. The fan wheel 8 and the motor shaft 9 thus act as an antenna, wherein the data signals coupled therein are conducted out of the cooking chamber 2 via the motor shaft 9, for example as far as the drive motor 10 and the mounting thereof. As a result, a relatively strong stray field SF in the 433 MHz ISM band, in which the data signals are contained, is generated outside the cooking chamber 2 in the region of the motor shaft 9 and the drive motor 10.

The stray field SF is picked up by a free-standing antenna 13 spaced apart from the motor unit (comprising at least the motor shaft 9, the mounting thereof and the drive motor 10) and forwarded as a “receiving signal” via a shielded or unshielded antenna line 14, in this case by way of example a coaxial line, to a receiver 15 or transceiver. In the receiver 15, the data signals are extracted from the receiving signal, for example demodulated, and for example forwarded to a control unit 16 and/or other components of the cooking appliance 1 such as a screen, etc. In particular, the receiver 15 can convert the data signals into digital temperature values by means of an analog-digital converter. The digital temperature values can be transmitted, for example, to a different component as a digital bus signal for further processing.

The control unit 16 can then control an operation of the cooking appliance 1 using the measured temperature values of the core temperature probe 3 contained in the data signals, for example vary an energy coupling and/or terminate a cooking process.

There is, therefore, a leakage path LP for radio waves in the 433 MHz ISM band from the transmitter 12, through the cooking chamber 2 and onward through the slots of the baffle wall 7 to the fan wheel 8 and the motor shaft 9 and then toward the outside along the motor shaft 9, and therefrom by means of the stray field SF via an air gap 17 to the antenna 13. At the same time, the cooking appliance 1 is constructed such that a decoupling of microwaves in the 2.4 GHz band via the motor shaft 9 is highly attenuated and a set limit value cannot be exceeded. At the same time, the hot fan subassembly 8 to 10 does not have to be altered mechanically, i.e. for example the fan wheel 8 and the motor shaft 9 do not have to be specifically adapted for decoupling the data signals. This avoids a potentially complex mechanism which is susceptible to failure, problems in signal reception and additional costs. In particular, since the signal is not picked up by the antenna galvanically but contactlessly by means of the electromagnetic stray field SF, it is not necessary to provide any sliding contact structures or brush structures which can lead to contact problems over time and which would disrupt a reliable reception of the data signal and can lead to acoustic interference. Rather, the signal which is picked up by means of the electromagnetic stray field SF results in a very simple way to receive the decoupled data signal and to conduct the data signal to the receiver 15.

It is sufficient, for example, to use an electrical antenna line 14 in the form of an electrically insulated wire, the end region thereof facing the motor shaft 9 being stripped of insulation and thus serving as an antenna 13. The antenna 13 is inductively or capacitively coupled to the motor shaft 9 and/or the hot air motor 10 (with a small spacing via the air gap 17). The other end of the wire is connected to the input of the receiver 15. It is also possible to use a shielded line as an antenna line 14 in order to prevent electromagnetic interference from being coupled in. This line 14 is advantageously designed as a coaxial line or a twisted pair line, wherein the electromagnetic shield, for example, can be connected to the receiver 15. In many cases, a further improvement results when the antenna line 14 is routed in the vicinity of large ground surfaces (housing plate, intermediate rear wall, etc.). As a result, impedance conditions can be kept substantially constant and electromagnetic interference substantially avoided.

In principle, the shape of the antenna 13 is not limited and can be formed as a coil, for example. The antenna 13 can be placed so as to be spaced apart entirely or in some portions around the motor shaft, in particular for an inductive coupling. In principle, the amplitude of the receiving signal coupled into the antenna 13 can be increased in the case of a coil by increasing the number of windings. In the case of a capacitive connection, an amplitude can be increased by reducing the spacing or enlarging the surface areas of the capacitively coupled elements of a correspondingly configured antenna 13.

In this case, the receiver 15 is advantageously configured as receiver electronics, which may require the use of a printed circuit board 15a. The printed circuit board 15a has, for example, the antenna 13 and the receiver 15. The antenna line 14 can thus optionally be dispensed with. The antenna 13 and, if present, the antenna line 14 can be implemented as printed conductors on the printed circuit board 15a, for example by galvanizing, printing, etc. The receiver 15 with the printed circuit board 15a, the antenna 13 and optionally the antenna line 14 can be regarded, in particular, as components of a receiver module 18 which can be handled as a unit. The module design provides the advantage that no high-frequency signals have to be transported via additional lines. This in turn saves costs and reduces possible interference by and on the data signals. It is one development that the printed circuit board 15a has a recess which is arranged at least in some portions around the motor shaft 9, for example in a U-shaped manner. An antenna 13 which is configured as a coupling surface for the stray field SF is arranged, in particular, on an edge region, which is for example U-shaped and which is guided around the motor shaft 9.

If the hot fan subassembly 8 to 10 is considered as an electromagnetic source, a certain source impedance of the antenna 13 is also present. In order to achieve the best possible pick-up of the stray field SF, the antenna 13 and optionally the antenna line 14 should be adapted together to the electromagnetic impedance of the hot fan subassembly 8 to 10. This can be achieved, for example, by adapting the antenna line 14 and/or by means of an LC matching network on the receiver input 15.

Naturally the present invention is not limited to the exemplary embodiment shown.

Thus, additionally or alternatively, at least one further antenna can be present in order to pick up a stray field present outside the muffle, and can be connected to a receiver or transceiver which converts the receiving signals received by the antenna into digital data signals.

Generally “a”, “an”, etc. can be understood to mean a singular or a plural, in particular in the sense of “at least one” or “one or more”, etc. provided this is not explicitly excluded, for example, by the expression “exactly one”, etc.

A numerical specification can also include exactly the specified number and also a usual tolerance range provided this is not explicitly excluded.

### LIST OF REFERENCE SIGNS

1 Cooking appliance
2 Cooking chamber
3 Core temperature probe
4 Muffle
5 Door
6 Microwave generating device
7 Baffle wall
7a Ventilation slot
8 Fan wheel
9 Motor shaft
10 Drive motor
11 Grip of core temperature probe
12 Transmitter
13 Antenna
14 Antenna line
15 Receiver
15a Printed circuit board
16 Control unit
17 Air gap
18 Receiver module
G Food to be cooked
LP Leakage path
SF Stray field

1-13. (canceled)

14. A cooking appliance, comprising:
a closable cooking chamber including a leakage path, arranged between the cooking chamber and its outer surroundings, for electromagnetic waves; and
a free-standing antenna, arranged in the outer surroundings of the cooking chamber, for data signals transmitted via the leakage path, said antenna being connected to a transmission and/or receiving circuit for the data signals.

15. The cooking appliance of claim 14, further comprising an electrical conductor routed through a boundary of the cooking chamber in the leakage path, said antenna being arranged spaced apart from the electrical conductor and designed to exchange the data signals with the electrical conductor.

16. The cooking appliance of claim 15, wherein the electrical conductor is a part of a functional part protruding into the cooking chamber from the outer surroundings of the cooking chamber.

17. The cooking appliance of claim 15, wherein the electrical conductor is at least one member selected from the group consisting of a motor shaft of a hot air motor, a grill heating element, a lamp structure, a sensor element, an actuator element, an electrical supply line, and a fastening element.

18. The cooking appliance of claim 14, wherein the leakage path between the cooking chamber and the outer surroundings is an air path.

19. The cooking appliance of claim 18, wherein the air path leads through a slot formed in a boundary of the cooking chamber.

20. The cooking appliance of claim 14, wherein the cooking appliance has a microwave function.

21. The cooking appliance of claim 20, wherein the electromagnetic waves used for transporting the data signals are in a frequency range outside a microwave frequency band used for the microwave function.

22. The cooking appliance of claim 20, wherein the electromagnetic waves used for transporting the data signals are in a frequency range within an ISM band for the microwave function.

23. The cooking appliance of claim 22, wherein the electromagnetic waves used for transporting the data signals are in a frequency range of the 433 MHz ISM band.

24. The cooking appliance of claim 14, wherein the leakage path is designed to cause an attenuation of microwaves and a lower attenuation of the data signals.

25. The cooking appliance of claim 19, wherein the slot is attenuating for microwaves and serves as a resonator for the data signals.

26. A system, comprising:
a cooking appliance comprising a closable cooking chamber including a leakage path, arranged between the cooking chamber and its outer surroundings, for electromagnetic waves, and a free-standing antenna, arranged in the outer surroundings of the cooking chamber, for data signals transmitted via the leakage path, said antenna being connected to a transmission and/or receiving circuit for the data signals; and
a functional unit for arrangement in the cooking chamber, said functional unit including a wireless transmission and/or receiving device for the data signals,
wherein, when the cooking chamber is closed, data signals are transmittable between the transmission and/or receiving device and a transmission and/or receiving circuit of the cooking appliance via the leakage path.

27. A method, comprising transmitting data signals between a functional unit arranged in a closed cooking chamber of a cooking appliance and a transmission and/or receiving circuit arranged in outer surroundings of the cooking chamber via a leakage path arranged between the cooking chamber and its outer surroundings.

28. The method of claim 27, further comprising:
routing an electrical conductor through a boundary of the cooking chamber in the leakage path;
arranging an antenna spaced apart from the electrical conductor in the outer surroundings of the cooking chamber, and
exchanging via the antenna the data signals with the electrical conductor.

29. The method of claim 27, wherein the leakage path between the cooking chamber and the outer surroundings is an air path.

30. The method of claim 27, further comprising leading the air path through a slot formed in the boundary of the cooking chamber.

31. The method of claim 30, wherein the slot is attenuating for microwaves and serves as a resonator for the data signals.

32. The method of claim 27, further comprising using electromagnetic waves for transporting the data signals in a frequency range within an ISM band used for a microwave function of the cooking appliance.

33. The method of claim 32, wherein the electromagnetic waves used for transporting the data signals are in a frequency range of the 433 MHz ISM band.
